(19) United States
(12) Patent Application Publication
(10) Pub. No.: US 2026/0080073 A1
(43) Pub. Date: Mar. 19, 2026

(54) IDENTIFICATION INFORMATION ENCRYPTION SYSTEM

(71) Applicant: Hi-health technology co., Taipei City (TW)

(72) Inventors: Chih-Chao Hsu, Taipei City (TW); Yu-Hsueh Wu, Taipei City (TW)

(21) Appl. No.: 19/328,741

(22) Filed: Sep. 15, 2025

(30) Foreign Application Priority Data
Sep. 19, 2024 (TW) 113210185

(51) Int. Cl. G06F 21/60

(52) U.S. Cl. CPC G06F 21/602

(57) ABSTRACT

An identification information encryption system includes a terminal, a first server end, and a second server end. The terminal is configured to send confidential information, which includes general information and identification information. The first server end is coupled to the terminal, and includes a first processor and a memory. The first processor is configured to read the confidential information, determine content and coordinates of the identification information based on a first machine learning model, and replace the identification information with encryption information, to generate de-identification confidential information. The memory is coupled to the first processor, and is configured to store the content and the coordinates of the identification information. The second server end is coupled to the first server end, and includes a second processor. The second processor is configured to read the de-identification confidential information, and process the de-identification confidential information based on a second machine learning model.

### CROSS-REFERENCE TO RELATED APPLICATION

This non-provisional application claims priority under 35 U.S.C. § 119(a) to Patent Application No. 113210185 filed in Taiwan, R.O.C. on Sep. 19, 2024, the entire contents of which are hereby incorporated by reference.

### BACKGROUND

### Technical Field

The present invention relates to an information processing system, and in particular, to an identification information processing system.

### Related Art

With accelerated development of digital transformation of commercial or clinic services, enterprises increasingly rely on artificial intelligence technologies to process and analyze massive commercial or clinic data. However, when the data relates to confidential information, there is a significant risk of information security if the data is uploaded to an artificial intelligence model of a third party for processing. In particular, leakage of confidential information may cause the enterprises to face huge financial losses and reputation damage.

Therefore, on the premise of ensuring data privacy, how to securely deliver data to a third party to process the data by fully using artificial intelligence technologies is a significant challenge currently faced in the field of digital security by enterprises.

### SUMMARY

In view of this, the present application application proposes an identification information encryption system, including a terminal, a first server end, and a second server end. The terminal is configured to send confidential information, and the confidential information includes general information and identification information. The first server end is coupled to the terminal, and includes a first processor and a memory. The first processor is configured to read the confidential information, determine content and coordinates of the identification information based on a first machine learning model, and replace the identification information with encryption information, to generate de-identification confidential information. The memory is coupled to the first processor, and is configured to store the content and the coordinates of the identification information. The second server end is coupled to the first server end, and includes a second processor. The second processor is configured to read the de-identification confidential information, and process the de-identification confidential information based on a second machine learning model.

The present application further proposes another identification information encryption system, configured to be coupled to a second server end. The identification information encryption system includes a terminal and a first server end. The terminal is configured to send confidential information, and the confidential information includes general information and identification information. The first server end is coupled to the terminal, and includes a first processor and a memory. The first processor is configured to read the confidential information, determine content and coordinates of the identification information based on a first machine learning model, replace the identification information with encryption information, to generate de-identification confidential information, and transmit the de-identification confidential information to the second server end. The memory is coupled to the first processor, and is configured to store the content and the coordinates of the identification information.

The present application further proposes another identification information encryption system, configured to be coupled to a terminal. The identification information encryption system includes a first server end and a second server end. The first server end is coupled to the terminal, and includes a first processor and a memory. The first processor is configured to read confidential information from the terminal, where the confidential information includes general information and identification information, and the first processor is configured to determine content and coordinates of the identification information based on a first machine learning model, and replace the identification information with encryption information, to generate de-identification confidential information. The memory is coupled to the first processor, and is configured to store the content and the coordinates of the identification information. The second server end is coupled to the first server end, and includes a second processor. The second processor is configured to read the de-identification confidential information, and process the de-identification confidential information based on a second machine learning model.

### BRIEF DESCRIPTION OF THE DRAWINGS

FIG. 1 is a schematic block diagram of an identification information encryption system according to a first embodiment;

FIG. 2 is a schematic diagram of an information flow of an identification information encryption system according to some embodiments;

FIG. 3A is a schematic diagram of confidential information according to some embodiments;

FIG. 3B is a schematic diagram of de-identification confidential information according to some embodiments;

FIG. 3C is a schematic diagram of processed de-identification confidential information according to some embodiments;

FIG. 3D is a schematic diagram of re-identification confidential information according to some embodiments;

FIG. 4A is a schematic diagram of confidential information according to some other embodiments;

FIG. 4B is a schematic diagram of de-identification confidential information according to some other embodiments;

FIG. 5 is a schematic block diagram of a first server end according to some embodiments;

FIG. 6 is a schematic block diagram of an identification information encryption system according to a second embodiment; and

FIG. 7 is a schematic block diagram of an identification information encryption system according to a third embodiment.

### DETAILED DESCRIPTION

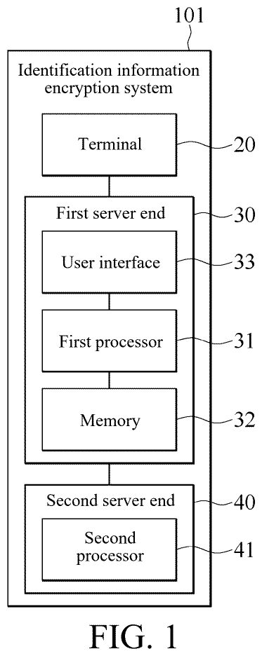

FIG. 1 is a schematic block diagram of an identification information encryption system according to a first embodiment. Refer to FIG. 1. In this embodiment, an identification information encryption system 101 includes a terminal 20, a first server end 30, and a second server end 40. The terminal 20 is coupled to the first server end 30, and the first server end 30 is coupled to the second server end 40. The first server end 30 includes a first processor 31 and a memory 32, and the first processor 31 is coupled to the memory 32. The second server end 40 includes a second processor 41. The being coupled to may refer to data transmission using an electrical connection, or a wired or wireless communication connection.

For the electrical connection, information transmission may be performed through a transmission protocol, for example, a serial peripheral interface (SPI), an inter-integrated circuit (I²C), RS-232, or a transistor-transistor logic (TTL) circuit.

For the wired or wireless communication connection, information transmission may be performed through a transmission protocol, for example, a global system for mobile communication (GSM), a personal handy-phone system (PHS), a code division multiple access (CDMA) system, a wideband code division multiple access (WCDMA) system, a long term evolution (LTE) system, a worldwide interoperability for microwave access (WiMAX) system, wireless fidelity (Wi-Fi), ZigBee, Bluetooth, or radio frequency (RF).

An SoC chip, a central processing unit (CPU), a micro-control unit (MCU), an application specific integrated circuit (ASIC), a field programmable gate array (FPGA), a logic circuit, or the like may be used as each of the first processor 31 and the second processor 41.

A phase-change memory (PRAM), a static random access memory (SRAM), a dynamic random access memory (DRAM), another type of RAM, ROM, an electrically-erasable programmable read-only memory (EEPROM), a flash memory or another storage technology, a compact disc read-only memory (CD-ROM), a digital versatile disc (DVD), a magnetic disk, a magnetic tape, a portable disk, a hard disk, a memory card, cloud storage space, or the like may be used as the memory 32.

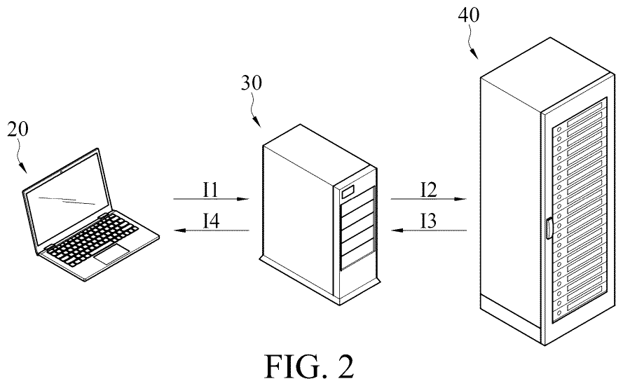

FIG. 2 is a schematic diagram of an information flow of an identification information encryption system according to some embodiments. Refer to FIG. 2. A terminal 20 is configured to send confidential information I1. The confidential information I1 includes general information and identification information. A difference between the general information and the identification information may be defined by a manager, or the manager provides samples of a plurality of pieces of identification information to a machine learning model for training, to make the machine learning model determine identification information included in the confidential information I1, and information other than the identification information is defined as the general information. In some embodiments, the manager provides samples of a plurality of pieces of different types of identification information to the machine learning model for training, to make the machine learning model have a capability of adapting to the different types of identification information.

The confidential information I1 may be a character, a voice, a picture, a film, or another type of information. A machine learning algorithm is applicable to one or more information types. For example, in the machine learning algorithm, a convolutional neural network (CNN) model may be used to classify or identify an image, to find identification information on the image; or a model like a recurrent neural network (RNN) or a long short-term memory (LSTM) may be used to handle an issue of classifying or identifying a film, a voice, or a text. In some embodiments, the machine learning algorithm includes an input layer, a hidden layer, and an output layer. The input layer may include a plurality of input ports and neurons, to receive a plurality of features. A neuron of the hidden layer is connected to a neuron of the input layer, and is connected to a neuron of the output layer or another hidden layer. An excitation function and hyperparameters of a neuron may be preset during training, for example, parameters such as a quantity of hidden layer neurons, an initial weight, an initial deviation, and a learning rate, and parameters such as a weight and a deviation value of each neuron may alternatively be adjusted during a training process. Each neuron receives a plurality of input values, multiplies the plurality of input values by the weight, adds the deviation, calculates a sum, and outputs the sum through the excitation function. In response to different models, the parameters include a weight that is set for each neuron function, for example, a weight of a hidden layer in a CNN model, or a weight of a function like an input gate, an output gate, or a forget gate used for updating a status in an LSTM model. The output layer outputs an identification result. The foregoing parameters such as the weight and the deviation value, and model settings such as a model type, a quantity of hidden layers, and an excitation function may be stored in the memory 32 after model training is completed.

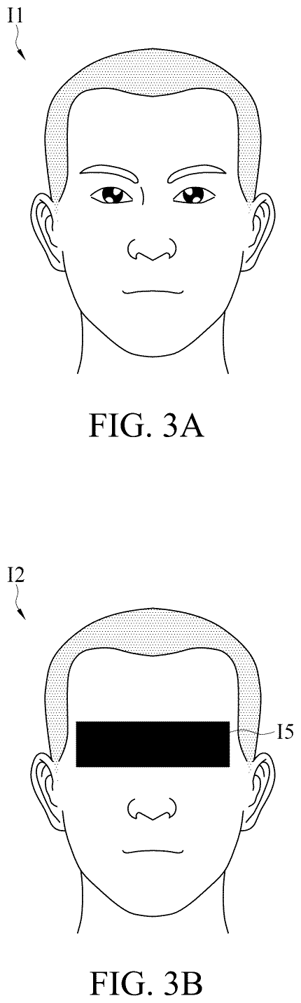

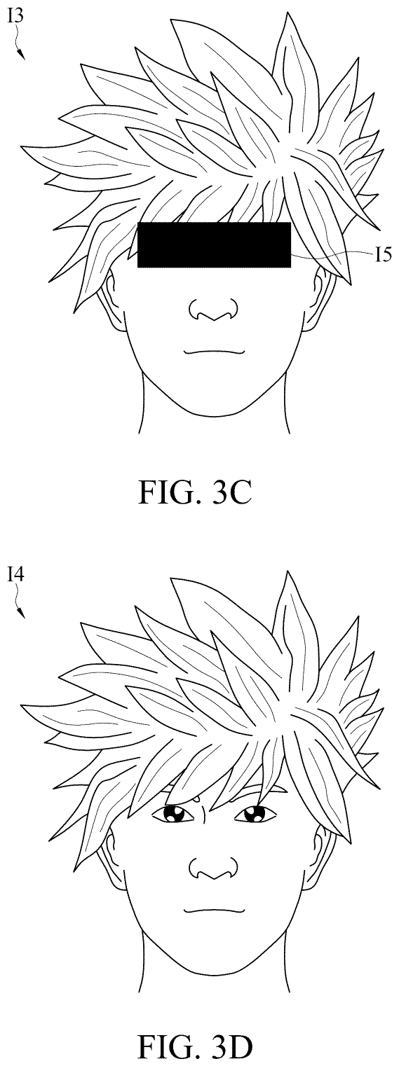

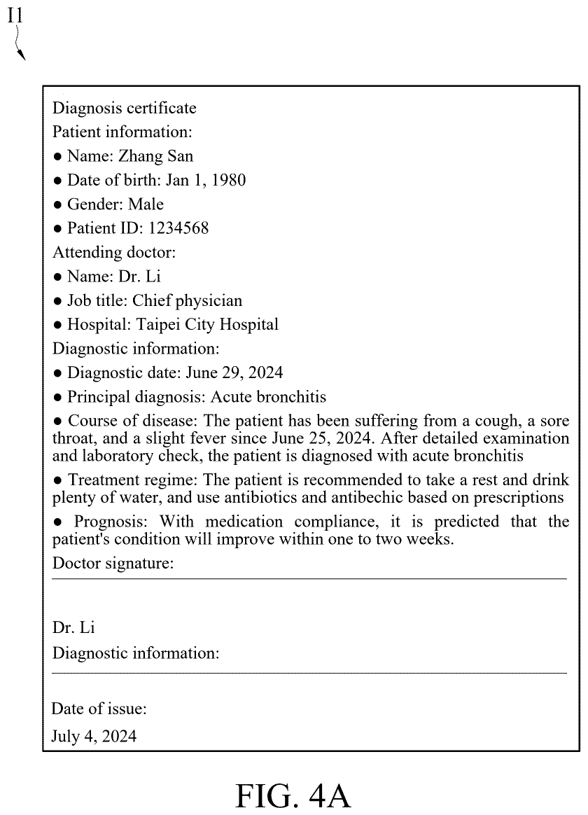

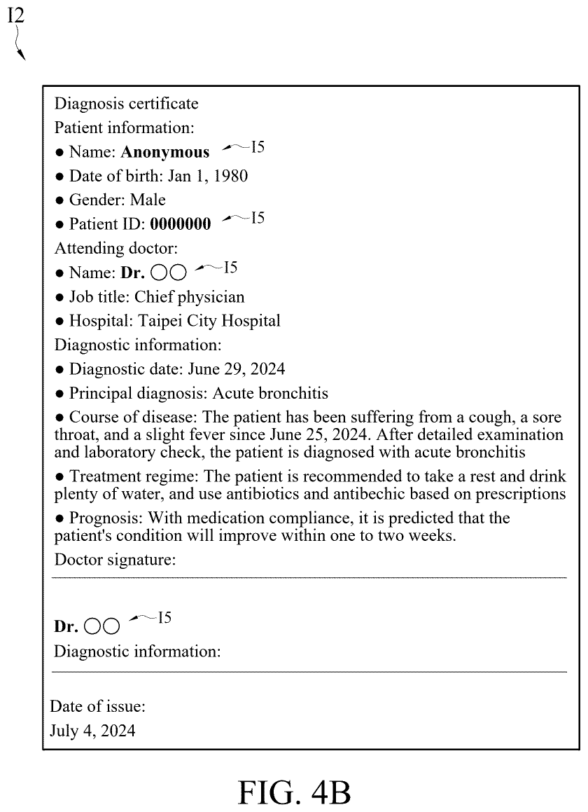

The first server end 30 receives the confidential information I1. The first processor 31 reads the confidential information I1, determines content and coordinates of the identification information based on a machine learning algorithm, and replaces the identification information with encryption information I5, to generate de-identification confidential information I2. FIG. 3A is a schematic diagram of confidential information according to some embodiments, and FIG. 3B is a schematic diagram of de-identification confidential information according to some embodiments. Refer to FIG. 3A and FIG. 3B together. In this embodiment, the confidential information I1 is facial portrait information, an identification information pair is defined as an eye feature, and the general information is another facial feature. Therefore, the first processor 31 determines, based on the machine learning algorithm, that content of the identification information is two eyes on an image, and coordinates of the identification information are located within a pixel range of a middle part of the image. In addition, the first processor 31 covers the eye feature within the foregoing pixel range with black square encryption information I5, to generate de-identification confidential information I2. FIG. 4A is a schematic diagram of confidential information according to some other embodiments, and FIG. 4B is a schematic diagram of de-identification confidential information according to some other embodiments. Refer to FIG. 4A and FIG. 4B together. In this embodiment, confidential information I1 is a diagnosis certificate, an identification information pair is defined as a “name” and a “patient ID”, and general information is other text information. Therefore, the first processor 31 determines, based on a machine learning algorithm, that content of the identification information is “Zhang San”, “123456”, and “Dr. Li” on the text, and coordinates of the identification information are located on the third line, the sixth line, the eighth line, and the last-but-three line of the text. In addition, the first processor 31 covers a character feature of the foregoing row coordinates with encryption information I5 of a preset character, to generate de-identification confidential information I2.

In some embodiments, the first processor 31 stores the content and the coordinates of the identification information in the memory 32, and transmits the de-identification confidential information I2 to the second server end 40. Based on an information type of the confidential information I1, the content of the identification information may be a character, a voice, a picture, or a partial segment or feature of a film. The coordinates of the identification information may be absolute coordinates or relative coordinates. For example, a row and column position of a character on a text, or a relative position of a character (identification information) relative to another character (general information). For example, a pixel position of an image feature on a picture, or a relative position of an image feature (identification information) relative to another image feature (general information).

The second server end 40 receives the de-identification confidential information I2. The second processor 41 reads the de-identification confidential information I2, and processes the de-identification confidential information I2 based on the machine learning algorithm. The second processor 41 may perform different processing on the de-identification confidential information I2 based on a purpose thereof, for example, information classification, marking, regression prediction, recognition, natural language processing, or image processing. FIG. 3C is a schematic diagram of processed de-identification confidential information according to some embodiments. Refer to FIG. 3C. For example, the machine learning algorithm of the second processor 41 in this embodiment relates to image processing, to replace a hair feature on facial portrait information. Confidential information I1 includes general information and identification information, and after the identification information is replaced with encryption information I5, de-identification confidential information I2 is generated. Therefore, the de-identification confidential information I2 includes the general information and the encryption information I5. In some embodiments, the machine learning algorithm of the second processor 41 processes only the general information of the de-identification confidential information I2. In other words, the encryption information I5 is not processed. For example, in FIG. 3C, the machine learning algorithm of the second processor 41 does not process encryption information I5 of a black square. In some embodiments, the first processor 31 is further configured to send the coordinates of the identification information to the second server end 40. The second processor 41 confirms coordinates of the encryption information I5 based on the coordinates of the identification information, to process the general information on the de-identification confidential information I2.

Refer to FIG. 2 again. In some embodiments, the first processor 31 is further configured to receive processed de-identification confidential information I3 from the second server end 40, and replace the encryption information I5 with the identification information based on the content and the coordinates of the identification information, to generate re-identification confidential information I4. In some embodiments, the first server end 30 further transmits the re-identification confidential information I4 to the terminal 20. FIG. 3D is a schematic diagram of re-identification confidential information according to some embodiments. Refer to FIG. 3C and FIG. 3D together. In this embodiment, the first processor 31 reads content of the identification information (that is, two eyes on the image) and coordinates of the identification information (that is, a pixel range of a middle part of the image) from the memory 32, and replaces the encryption information I5 on the processed de-identification confidential information I3 with the identification information. In this way, even if the first server end 30 sends the de-identification confidential information I2 to the second server end 40, the second server end 40 cannot obtain the identification information in a processing process. In addition, the first server end 30 may send the re-identification confidential information I4 including the identification information back to the terminal 20. Based on this, a manager only needs to perform information security management and control on the terminal 20, the first server end 30, and an information transmission interface in between, to ensure information security.

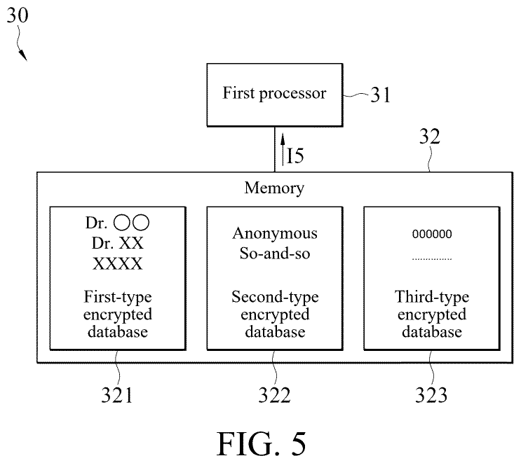

FIG. 5 is a schematic block diagram of a first server end according to some embodiments. Refer to FIG. 5. In this embodiment, a memory 32 stores a first-type encrypted database 321, a second-type encrypted database 322, and a third-type encrypted database 323. The databases may refer to data stored at different addresses on the memory 32. The first-type encrypted database 321, the second-type encrypted database 322, and the third-type encrypted database 323 respectively include encryption information I5 of different types. For example, the first-type encrypted database 321 is configured to store encryption information I5 associated with a type “doctor name”, including encryption information I5 like “Dr. OO”, “Dr. XX”, or “XXXX”; the second-type encrypted database 322 is configured to store encryption information I5 associated with a type “patient name”, including encryption information I5 like “anonymous” or “so-and-so”; and the third-type encrypted database 323 is configured to store encryption information I5 associated with a type “patient ID”, including encryption information I5 like “000000” or “ . . . ”. The first processor 31 determines, based on a type of content of the identification information, to read the encryption information I5 from the first-type encryption database 321, the second-type encryption database 322, or the third-type encryption database 323, to replace the identification information on the confidential information I1. Therefore, the identification information encryption system 101 can adapt to different types of identification information on the confidential information I1. In some embodiments, the first processor 31 may randomly select one piece of encryption information I5 from a plurality of pieces of encryption information I5 included in one database thereof, to replace the identification information. Alternatively, in some embodiments, each database includes only one piece of encryption information I5, and the first processor 31 selects, based on a type of content of the identification information, the piece of encryption information I5 included in one database thereof.

Refer to FIG. 1 again. In this embodiment, the first server end 30 includes the first processor 31, the memory 32, and the user interface 33. The first processor 31 is coupled to the memory 32, and the user interface 33 is coupled to the first processor 31. A mouse, a keyboard, a touchpad, a touch screen, a laser pointer, a camera, a microphone, or the like may be used as the user interface 33. The user interface 33 receives a setting instruction of the manager, and the first processor 31 receives the setting instruction to adjust determining logic of replacing the identification information based on the encryption information I5.

A potential technical problem of replacing the identification information based on the encryption information I5 lies in how to achieve a balance between hiding sensitive information (e.g. identification information) and reserving feature information. For example, during application of a second machine learning algorithm to facial recognition, specific feature information, for example, an eye feature of a facial portrait, may be needed for determining. However, same pixels in an image may include both the sensitive information and the feature information (for example, FIG. 3C). If the sensitive information is excessively hidden, accuracy of the second machine learning algorithm may be affected. However, if too much of the feature information is reserved, privacy may not be sufficiently protected, resulting in an information security problem. Therefore, in some embodiments, the identification information encryption system 101 sets an encryption level of the identification information through the user interface 33, and the first processor 31 determines, based on the encryption level of the identification information, whether to replace the identification information with the encryption information I5. For example, refer to FIG. 4A and FIG. 4B. In this embodiment, the second machine learning algorithm may be applied to determine diagnosis accuracy of different doctors. In this case, names of the doctors may relate to both the sensitive information and the feature information, and a name of a patient may relate to only the sensitive information. Therefore, the manager may generate a setting instruction through the user interface 33, to adjust encryption levels of different identification information. For example, an encryption level of a name of a doctor decreases, and an encryption level of a name of a patient remains high. The first processor 31 determines, for identification information determined to have an encryption level lower than a threshold, not to replace the identification information with the encryption information I5; and for identification information determined to have an encryption level higher than the threshold, to replace the identification information with the encryption information I5.

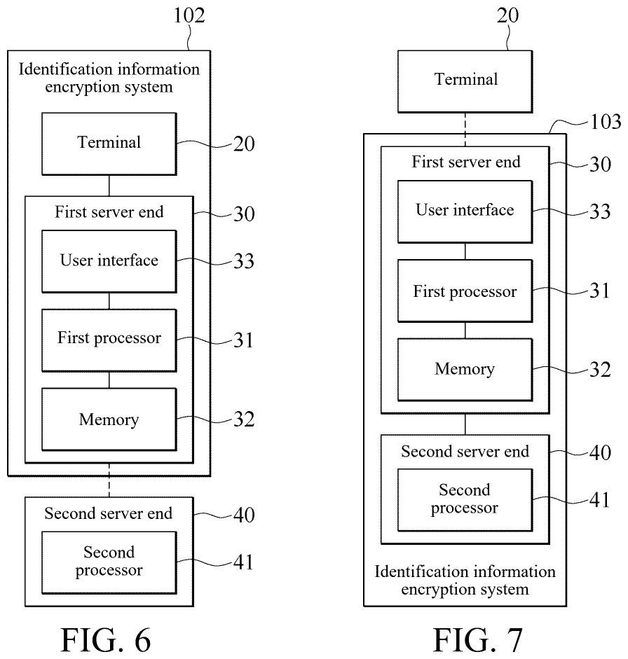

FIG. 6 is a schematic block diagram of an identification information encryption system according to a second embodiment. Refer to FIG. 6. In this embodiment, an identification information encryption system 102 includes a terminal 20 and a first server end 30. The terminal 20 is coupled to a first server end 30. The first server end 30 may be coupled to an external second server end 40. The first server end 30 includes a first processor 31 and a memory 32, and the first processor 31 is coupled to the memory 32. In this embodiment, the first server end 30 may send de-identification confidential information I2 to the external second server end 40, and receive processed de-identification confidential information I3 from the second server end 40.

FIG. 7 is a schematic block diagram of an identification information encryption system according to a third embodiment. Refer to FIG. 7. In this embodiment, an identification information encryption system 103 includes a first server end 30 and a second server end 40. The first server end 30 is coupled to the second server end 40, and the first server end 30 may be coupled to an external terminal 20. The first server end 30 includes a first processor 31 and a memory 32, and the first processor 31 is coupled to the memory 32. The second server end 40 includes a second processor 41. In this embodiment, the first server end 30 may receive confidential information I1 from the external terminal 20, and send re-identification confidential information I4 to the terminal 20.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An identification information encryption system, comprising:
a terminal, configured to send confidential information, wherein the confidential information comprises general information and identification information;
a first server end, coupled to the terminal, and comprising:
a first processor, configured to read the confidential information, determine content and coordinates of the identification information based on a first machine learning model, and replace the identification information with encryption information, to generate de-identification confidential information; and
a memory, coupled to the first processor, and configured to store the content and the coordinates of the identification information; and
a second server end, coupled to the first server end, and comprising:
a second processor, configured to read the de-identification confidential information, and process the de-identification confidential information based on a second machine learning model.

2. The identification information encryption system according to claim 1, wherein the first processor is further configured to receive the processed de-identification confidential information from the second server end, and replace the encryption information with the identification information based on the content and the coordinates of the identification information, to generate re-identification confidential information.

3. The identification information encryption system according to claim 2, wherein the first server end is further configured to transmit the re-identification confidential information to the terminal.

4. The identification information encryption system according to claim 1, wherein the memory is further configured to store a first-type encrypted database and a second-type encrypted database, the first-type encrypted database or the second-type encrypted database comprises the encryption information, and the first processor is further configured to determine, based on a type of the content of the identification information, to read the encryption information from the first-type encrypted database or the second-type encrypted database.

5. The identification information encryption system according to claim 1, wherein the confidential information is image information, and the coordinates are pixel coordinates of the identification information.

6. The identification information encryption system according to claim 1, wherein the confidential information is text information, and the coordinates are row and column coordinates of the identification information.

7. The identification information encryption system according to claim 1, wherein the confidential information is text information, and the coordinates are relative coordinates of the identification information relative to the general information.

8. The identification information encryption system according to claim 1, further comprising a user interface, coupled to the first processor, wherein the user interface is configured to set an encryption level of the identification information, and the first processor is further configured to determine, based on the encryption level of the identification information, whether to replace the identification information with the encryption information.

9. An identification information encryption system, configured to be coupled to a second server end, wherein the identification information encryption system comprises:
a terminal, configured to send confidential information, wherein the confidential information comprises general information and identification information; and
a first server end, coupled to the terminal, and comprising:
a first processor, configured to read the confidential information, determine content and coordinates of the identification information based on a first machine learning model, replace the identification information with encryption information, to generate de-identification confidential information, and transmit the de-identification confidential information to the second server end; and
a memory, coupled to the first processor, and configured to store the content and the coordinates of the identification information.

10. An identification information encryption system, configured to be coupled to a terminal, wherein the identification information encryption system comprises:
a first server end, coupled to the terminal, and comprising:
a first processor, configured to read confidential information from the terminal, wherein the confidential information comprises general information and identification information, the first processor is configured to determine content and coordinates of the identification information based on a first machine learning model, and replace the identification information with encryption information, to generate de-identification confidential information; and
a memory, coupled to the first processor, and configured to store the content and the coordinates of the identification information; and
a second server end, coupled to the first server end, and comprising:
a second processor, configured to read the de-identification confidential information, and process the de-identification confidential information based on a second machine learning model.
